(19) United States
(12) Patent Application Publication
(10) Pub. No.: US 2025/0208375 A1
(43) Pub. Date: Jun. 26, 2025

(54) OPTICAL ELEMENT DRIVING MECHANISM

(71) Applicant: TDK TAIWAN CORP., Taoyuan City (TW)

(72) Inventors: Jui-Che MENG, Taoyuan City (TW); Chao-Chang HU, Taoyuan City (TW); Chia-Che WU, Taoyuan City (TW); Yu-Chiao LO, Taoyuan City (TW); Sin-Jhong SONG, Taoyuan City (TW)

(21) Appl. No.: 18/988,258

(22) Filed: Dec. 19, 2024

Related U.S. Application Data
(60) Provisional application No. 63/612,581, filed on Dec. 20, 2023.

(51) Int. Cl. G02B 7/10

(52) U.S. Cl. CPC G02B 7/102

(57) ABSTRACT

An optical element driving mechanism is provided. The optical element driving mechanism includes a first movable portion, a fixed portion, and a first driving component. The first movable portion is configured to connect the first optical element. The first movable portion is movable relative to the fixed portion. The first driving component is configured to drive the first movable portion to move relative to the fixed portion.

### CROSS REFERENCE TO RELATED APPLICATIONS

This application claims the benefit of U.S. Provisional Application No. 63/612,581, filed Dec. 20, 2023, the entirety of which is incorporated by reference herein.

### BACKGROUND OF THE INVENTION

### Field of the Invention

The present invention relates to an optical element driving mechanism, in particular to a periscope optical element driving mechanism.

### Description of the Related Art

With the advancement of technology, many modern electronic devices (e.g., smartphones and tablets) are now equipped with photography and video recording functionality. The demand for such electronic devices continues to grow, driving development toward thinner, lighter, and higher-performance designs to provide users with more convenience and versatile options. Typically, electronic devices with photography or video recording capabilities include one or more lenses to enable features such as focusing, zooming, and Optical Image Stabilization (OIS). Among these, periscope lenses, with their unique refractive structures, can achieve higher optical zoom ratios within the constraints of limited device thickness, making them a critical technology for enhancing the imaging performance of electronic devices.

However, in the current state of the art, integrating liquid optical elements with periscope lenses still faces technical challenges. While liquid optical elements offer advantages such as simple structures, compact size, and smooth zooming capabilities, their limited compensation angle range makes it difficult to address the angle-shift requirements of periscope lenses under high zoom ratios, which can compromise image stability and quality. This invention provides an optical element driving mechanism designed to address the insufficient compensation angles of liquid optical elements. Through specific design and driving control mechanisms, the invention not only achieves an expanded compensation angle but also meets the optical requirements for periscope lenses, ensuring stable and clear images even in scenarios involving larger angle shifts.

### BRIEF SUMMARY OF THE INVENTION

The invention provides an optical element driving mechanism. The optical element driving mechanism includes a movable portion, a fixed portion and a driving component. The first movable portion is configured to connect the first optical element. The first movable portion is movable relative to the fixed portion. The first driving component is configured to drive the first movable portion to move relative to the fixed portion.

According to some embodiments of the present disclosure, the optical element driving mechanism further includes a second movable portion and a second driving component. The second movable portion is configured to connect the second optical element, and the first movable portion is movable relative to the second movable portion and movable relative to the fixed portion. The second driving component is configured to drive the second movable portion to move relative to the fixed portion.

### BRIEF DESCRIPTION OF THE DRAWINGS

Embodiments of the present disclosure are described in detail below with reference to the accompanying drawings. It should be noted that, consistent with standard practice in the industry, various features are not drawn to scale and are for illustrative purposes only. In fact, the dimensions of the elements may be arbitrarily enlarged or reduced in order to clearly illustrate the features of the present disclosure.

FIG. 1 shows a perspective view of an optical element driving mechanism according to some embodiments of the present disclosure.

FIG. 2 shows an exploded view of the optical element driving mechanism according to some embodiments of the present disclosure.

FIG. 3 is a perspective view of the optical element driving mechanism according to some embodiments of the present disclosure, in which a housing is not shown for illustration purposes.

FIG. 4 is a perspective view of a first movable portion, a first optical element, a second movable portion, a second optical element and a first flexible element of the optical element driving mechanism according to some embodiments of the present disclosure.

FIG. 5 shows the base, a first coil, a second coil, a third coil, a fourth coil, a first sensing component, a second sensing component and a circuit member depicted in dashed lines of the optical element driving mechanism according to some embodiments of the present disclosure.

FIG. 6 shows a top cross-sectional view of the optical element driving mechanism taken along line A-A of FIG. 1 according to some embodiments of the present disclosure.

FIG. 7 shows a block diagram of preset information of a control component of the optical element driving mechanism according to some embodiments of the present disclosure.

### DETAILED DESCRIPTION OF THE INVENTION

Unless otherwise defined, all terms (including technical and scientific terms) used herein have the same meaning as commonly understood by one of ordinary skill in the art. It is understood that these terms, such as those defined in commonly used dictionaries, should be interpreted in a manner consistent with the related art and the context or background of the present invention, rather than in an idealized or overly formal manner, unless specifically defined herein.

Furthermore, the ordinal terms such as “first,” “second,” and the like used in the specification and the claims to modify elements of the claims are not intended to imply any sequential order of these elements, nor do they indicate any specific order of manufacturing or arrangement between one element and another. The use of such ordinal terms is solely to clearly distinguish an element with a particular designation from another element with the same designation.

Additionally, in some embodiments of the present disclosure, terms related to engagement or connection, such as “connect” and “interconnect,” unless specifically defined otherwise, may refer to two structures that are in direct contact or to two structures that are not in direct contact, with other structures disposed between them. Such terms may also include cases where both structures are movable or where both structures are fixed.

In the descriptions of this specification, the terms “an embodiment,” “some embodiments,” “example,” and similar expressions mean that the specific features, structures, materials, or characteristics described in connection with the embodiment or example are included in at least one embodiment or example of the present disclosure. In this specification, the indicative expression of such terms does not necessarily refer to the same embodiment or example. Moreover, the specific features, structures, materials, or characteristics described may be combined in suitable ways in any one or more embodiments or examples. Additionally, a person of ordinary skill in the art may combine and integrate the different embodiments or examples described in this specification.

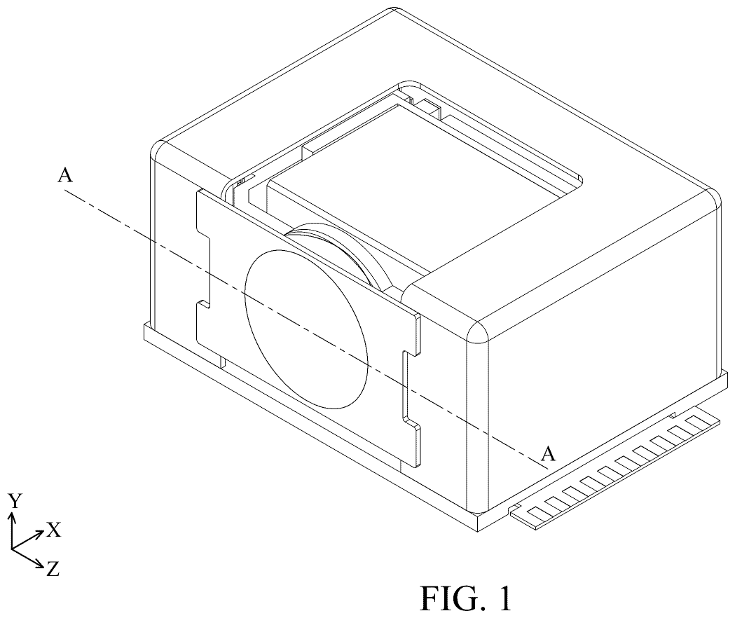

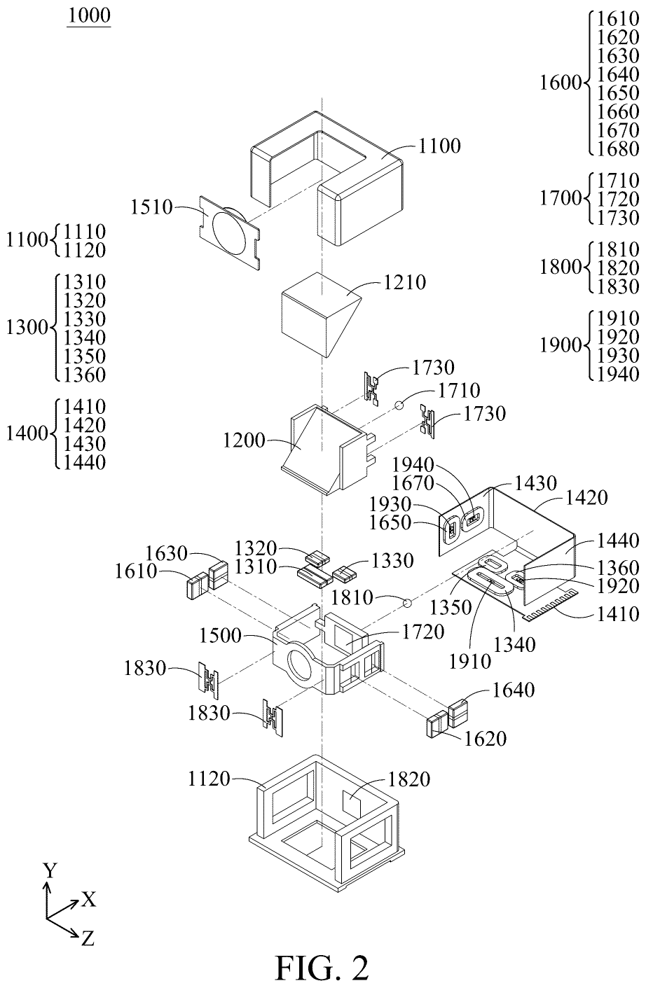

FIG. 1 shows a perspective view of an optical element driving mechanism 1000 according to some embodiments of the present disclosure. FIG. 2 shows an exploded view of the optical element driving mechanism 1000 according to some embodiments of the present disclosure. The overall structure of the optical element driving mechanism 1000 is described in detail below. Please refer to FIG. 1 and FIG. 2.

According to some embodiments of the present disclosure, the optical element driving mechanism 1000 includes a fixed portion 1100, a first movable portion 1200, a first optical element 1210, a first driving component 1300, a circuit member 1400, and a second movable portion 1500, a second optical element 1510, a second driving component 1600, a first support component 1700, a second support component 1800 and a control component 1900.

According to some embodiments of the present disclosure, the fixed portion 1100 includes a housing 1110 and a base 1120. The housing 1110 is fixedly connected to the base 1120 to form an accommodating space for accommodating other elements of the optical component driving mechanism 1000.

According to some embodiments of the present disclosure, the first movable portion 1200 is movable relative to the fixed portion 1100. The first movable portion 1200 is configured to connect the first optical element 1210. That is to say, the first movable portion 1200 is a carrier that carries the first optical element 1210.

In some embodiments, the first optical element 1210 is a prism capable of altering the light path. For example, the first optical element 1210 can adjust the traveling direction of light from a first axis (parallel to the Y-axis) to a second axis (parallel to the X-axis), wherein the first axis (parallel to the Y-axis) and the second axis (parallel to the X-axis) are not parallel to each other.

According to some embodiments of the present disclosure, the first driving component 1300 is configured to drive the first movable portion 1200 to move. The first driving component 1300 includes a first magnetic element 1310, two second magnetic elements 1320, 1330, a first coil 1340 and two second coils 1350, 1360.

According to some embodiments of the present disclosure, the first magnetic element 1310 and the second magnetic elements 1320 and 1330 are disposed at the bottom of the first movable portion 1200. The first coil 1340 and the second coils 1350 and 1360 are provided on the circuit member 1400. The first magnetic element 1310 corresponds to the first coil 1340, and the second magnetic elements 1320 and 1330 correspond to the second coils 1350 and 1360 respectively.

Specifically, when a driving signal (e.g., an electric current applied by an external power source) is applied to the first coil 1340, an electromagnetic inductive force is generated between the first magnetic element 1310 and the first coil 1340. This force drives the first movable portion 1200 to rotate in a direction parallel to the Z-axis, thereby positioning the first optical element 1210 at the desired location.

Similarly, when driving signals (e.g., electric currents applied by an external power source) are respectively applied to the second coils 1350 and 1360, electromagnetic inductive forces are generated between the second magnetic elements 1320, 1330 and the second coils 1350, 1360, respectively. These forces drive the first movable portion 1200 to rotate in a direction parallel to the Y-axis, thereby positioning the first optical element 1210 at the desired location.

According to some embodiments of the present disclosure, the circuit member 1400 is fixedly connected to base 1120. The circuit member 1400 includes a bottom surface 1410, a connecting portion 1420, and a pair of side portions 1430, 1440. The bottom surface 1410 is respectively connected to the pair of side portions 1430 and 1440 via the connecting portions 1420.

According to some embodiments of the present disclosure, the bottom surface 1410 is perpendicular to the connecting portion 1420 and the pair of side portions 1430, 1440. The connecting portion 1420 is perpendicular to the side portions 1430, 1440. The side portions 1430, 1440 are parallel to each other on opposite sides of the base 1120. The first coil 1340 and the second coils 1350 and 1360 are disposed on the bottom surface 1410.

According to some embodiments of the present disclosure, the second movable portion 1500 is movable relative to the fixed portion 1100, and the first movable portion 1200 is movable relative to the second movable portion 1500. The second movable portion 1500 is configured to movably connect the second optical element 1510. In some embodiments of the present disclosure, the second optical element 1510 is a liquid lens.

A liquid lens adjusts the focal length by changing the curvature of the interface of a transparent liquid, enabling rapid zooming through the control of the liquid shape using an electric field, magnetic field, or mechanical pressure. In some embodiments of the present disclosure, the second optical element 1510 is fixed to the housing 1110 and includes a light-transmissible body with a finite focal length. The second optical element 1510 adjusts the focal length by controlling the curvature of the liquid interface through mechanical pressure caused by the movement of the second movable portion 1500.

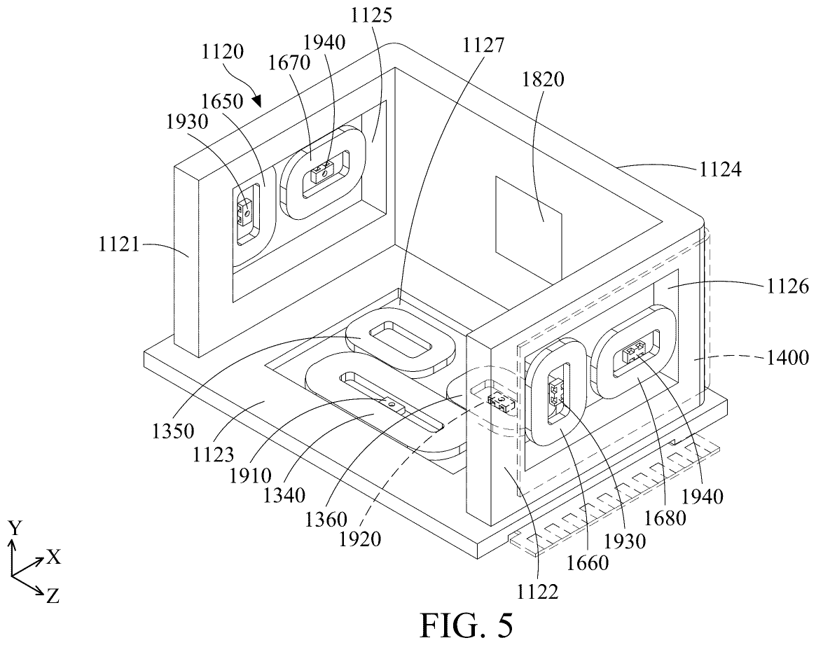

According to some embodiments of the present disclosure, the second driving component 1600 is configured to drive the second movable portion 1500 to move relative to the fixed portion 1100. The second driving component 1600 includes two third magnetic elements 1610, 1620, two fourth magnetic elements 1630, 1640, two third coils 1650, 1660 (FIG. 5), and two fourth coils 1670, 1680 (FIG. 5).

According to some embodiments of the present disclosure, the third magnetic elements 1610 and 1620 are respectively disposed on opposite sides of the second movable portion 1500, and the fourth magnetic elements 1630 and 1640 are also respectively disposed on opposite sides of the second movable portion 1500. The third magnetic element 1610 and the fourth magnetic element 1630 are disposed on the same side of the second movable portion 1500. The third magnetic element 1620 and the fourth magnetic element 1640 are disposed on the same side of the second movable portion 1500.

According to some embodiments of the present disclosure, the third coils 1650 and 1660 (FIG. 5) are respectively disposed on the side portions 1430 and 1440 of the circuit member 1400, and the fourth coils 1670 and 1680 (FIG. 5) are respectively disposed on the side portions 1430 and 1440 of the circuit member 1400.

When driving signals (e.g., electric currents applied by an external power source) are respectively applied to the third coils 1650 and 1660 (FIG. 5), electromagnetic inductive forces are generated between the third magnetic elements 1610, 1620 and the third coils 1650, 1660 (FIG. 5), respectively. These forces drive the second movable portion 1500 to rotate in a direction parallel to the Y-axis, thereby changing the curvature of the liquid interface of the second optical element 1510 to adjust the focal length.

Similarly, when driving signals (e.g., electric currents applied by an external power source) are respectively applied to the fourth coils 1670 and 1680 (FIG. 5), electromagnetic inductive forces are generated between the fourth magnetic elements 1630, 1640 and the fourth coils 1670, 1680 (FIG. 5), respectively. These forces drive the second movable portion 1500 to rotate in a direction parallel to the Z-axis, thereby changing the curvature of the liquid interface of the second optical element 1510 to adjust the focal length.

According to some embodiments of the present disclosure, the first movable portion 1200 is movable relative to the fixed portion 1100 via the first support component 1700, and the first movable portion 1200 is also movable relative to the second movable portion 1500 via the first support component 1700.

According to some embodiments of the present disclosure, the first support component 1700 includes a first support element 1710, a first corresponding element 1720, and a pair of first flexible elements 1730. In some embodiments of the present disclosure, the first support element 1710 may be a ball with ceramic material, and the first corresponding element 1720 may be a metal plate-like structure corresponding to the first support element 1710.

According to some embodiments of the present disclosure, the first support element 1710 is movable relative to the first corresponding element 1720. The first corresponding element 1720 may be embedded in the second movable portion 1500. The first flexible element 1730 has a flexible structure. The first flexible element 1730 is movably connected to the first movable portion 1200, and the first flexible element 1730 is movably connected to the second movable portion 1500.

According to some embodiments of the present disclosure, the second movable portion 1500 is movable relative to the fixed portion 1100 via the second support component 1800. When the second movable portion 1500 moves, the first movable portion 1200 will be driven to move relative to the fixed portion 1100. The second support component 1800 includes a second support element 1810, a second corresponding element 1820 and a pair of second flexible elements 1830.

In some embodiments of the present disclosure, the second support element 1810 may be a ball with ceramic material, and the second corresponding element 1820 may be a metal plate-like structure corresponding to the second support element 1810. The second support element 1810 is movable relative to the second corresponding element 1820.

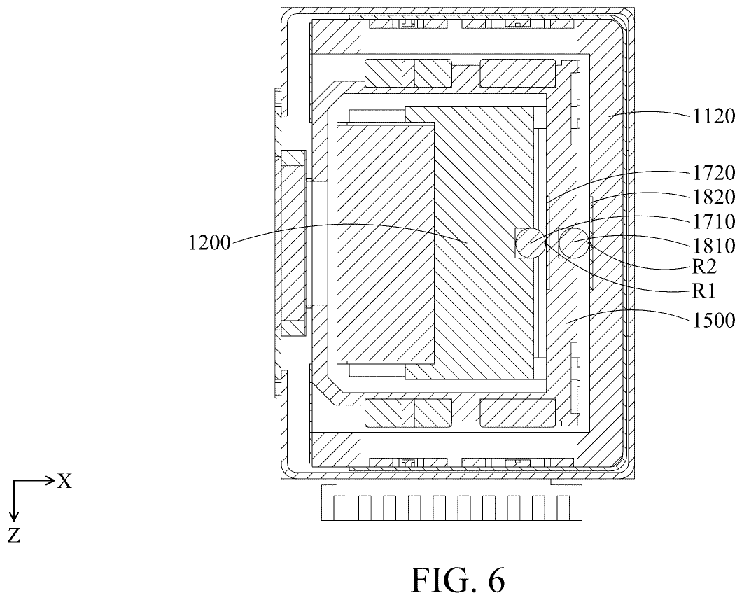

According to some embodiments of the present disclosure, the second flexible element 1830 has a flexible structure. The second flexible element 1830 is connected to the second movable portion 1500, and the second flexible element 1830 is connected to the fixed portion 1100. The first flexible element 1730 and the second flexible element 1830 are positioned on opposite sides of the first optical element 1210, and the first corresponding element 1720 is positioned between the first support element 1710 and the second support element 1810 (FIG. 6).

According to some embodiments of the present disclosure, the control component 1900 is configured to control the first driving component 1300 and the second driving component 1600. The control component 1900 includes a set of first sensing components 1910, 1920, two sets of second sensing components 1930, 1940, and a control unit (not shown), where in the perspective view of FIG. 2, only one set of second sensing components 1930 and 1940 is visible, while the other set of second sensing components 1930 and 1940 can be seen in FIG. 5.

According to some embodiments of the present disclosure, the first sensing components 1910 and 1920 are configured to sense the movement of the first movable portion 1200 and output a first sensing signal. The second sensing components 1930 and 1940 are configured to sense the movement of the second movable portion 1500 and output a second sensing signal.

According to some embodiments of the present disclosure, the control unit may be a control element encapsulated within the same package as the first sensing components 1910, 1920 and the second sensing components 1930, 1940, or a control element electrically connected to the first sensing components 1910, 1920 and the second sensing components 1930, 1940 via an external circuit.

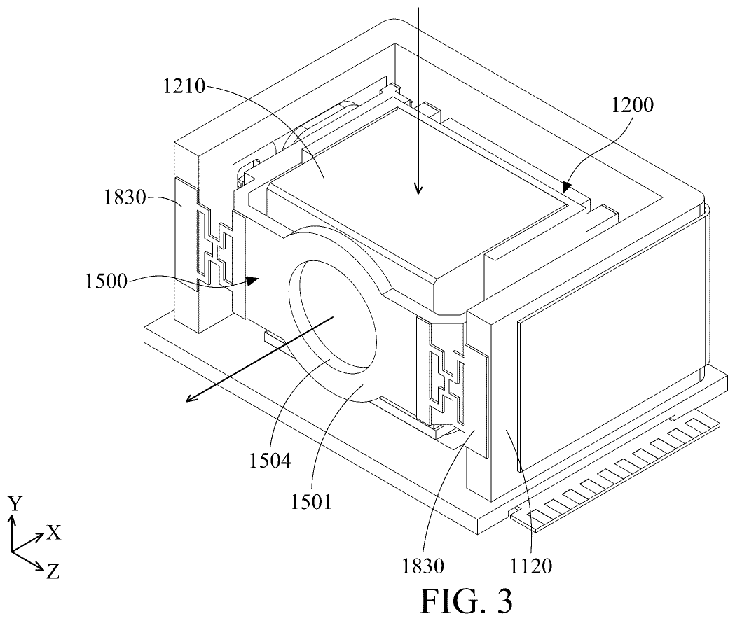

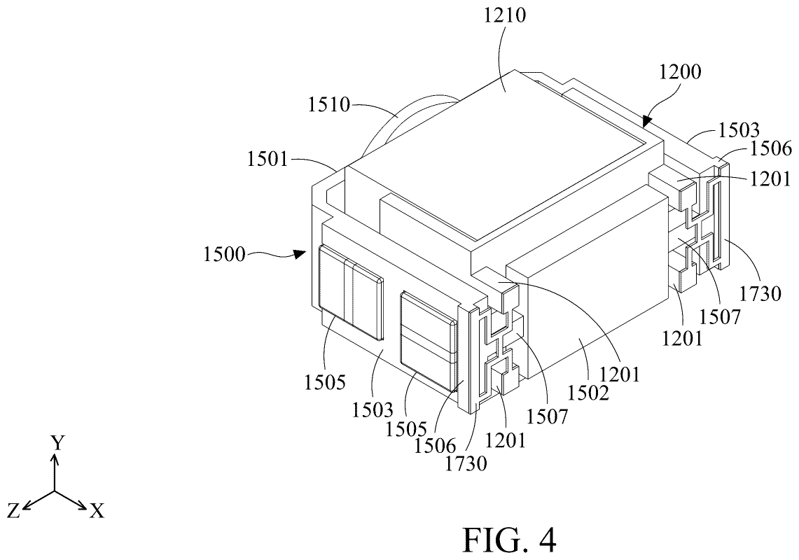

FIG. 3 is a perspective view of the optical element driving mechanism 1000 according to some embodiments of the present disclosure, in which the housing 1110 is not shown for illustration purposes. FIG. 4 shows the first movable portion 1200, the first optical element 1210, the second movable portion 1500, the second optical element 1510 and the first flexible element 1730 of the optical element driving mechanism 1000 according to some embodiments of the present disclosure.

Please refer to FIG. 3 and FIG. 4. As shown in FIGS. 3 and 4, the first movable portion 1200 includes four protrusions 1201 extending along the X direction. The second movable portion 1500 includes a front side 1501, a rear side 1502, a pair of side portions 1503, an opening 1504, four grooves 1505, a pair of end portions 1506 and a pair of extension portions 1507.

As shown in FIG. 4, the first movable portion 1200 is surrounded by the front side 1501, the rear side 1502 and the side portions 1503 of the second movable portion 1500. As shown in FIG. 3, the opening 1504 is positioned on the front side 1501. The light entering the optical element driving mechanism 1000 travels in the-Y direction into the first optical element 1210, exits the first optical element 1210 in the-X direction, and then enters the second optical element 1510 through the opening 1504 (FIG. 4).

As shown in FIG. 4, two grooves 1505 are located on the side portion 1503. Although the other two grooves on the opposite side are not visible in FIG. 4, it should be understood that the other two grooves 1505 are similarly positioned on the opposite side portion 1503. The four grooves 1505 are respectively used to accommodate the third magnetic elements 1610 and 1620, as well as the fourth magnetic elements 1630 and 1640 shown in FIG. 2.

As shown in FIG. 4, a pair of end portions 1506 are respectively located on a pair of side portions 1503 close to the rear side 1502. One end of the first flexible element 1730 is connected to the protrusion 1201 of the first movable portion 1200, and the other end of the first flexible element 1730 is connected to the end portion 1506 of the second movable portion 1500, so that the first movable portion 1200 is movably connected to the second movable portion 1500 through the first flexible element 1730.

As shown in FIG. 4, the extension portion 1507 of the second movable portion 1500 extends from the end portion 1506 through the space between the two protrusions 1201 of the first movable portion 1200 to the rear side 1502. As shown in FIG. 3, one end of the second flexible element 1830 is connected to the base 1120, and the other end of the second flexible element 1830 is connected to the front side 1501 of the second movable portion 1500.

FIG. 5 shows a perspective view of the base 1120, the first coil 1340, the second coils 1350 and 1360, the third coils 1650 and 1660, the fourth coils 1670 and 1680, the first sensing components 1910 and 1920, the second sensing components 1930 and 1940, and the circuit component 1400 shown in dashed lines of the optical element driving mechanism 1000 according to some embodiments of the present disclosure.

As shown in FIG. 5, the base 1120 includes a pair of opposite side surfaces 1121, 1122, a bottom surface 1123, a back surface 1124 and three openings 1125, 1126, 1127. The side surfaces 1121, 1122 and the back surface 1124 are perpendicular to the bottom surface 1123. The side surfaces 1121 and 1122 are respectively adjacent to the back surface 1124 and perpendicular to the back surface 1124.

As shown in FIG. 5, the opening 1125 is located in side surface 1121, the opening 1126 is located in side surface 1122, and the opening 1127 is located in bottom surface 1123. The first coil 1340 and the second coils 1350 and 1360 provided on the circuit member 1400 are located in the space formed by the opening 1127.

Similarly, the third coil 1650 and the fourth coil 1670 provided on the circuit member 1400 are positioned in the space formed by the opening 1125. The third coil 1660 and the fourth coil 1680 provided on the circuit member 1400 are positioned in the space formed by the opening 1126.

As shown in FIG. 5, the first sensing components 1910 and 1920 are respectively positioned in the spaces formed by the annular structures of the first coil 1340 and the second coil 1360. The two second sensing components 1930 are respectively positioned in the spaces formed by the annular structures of the third coils 1650, 1660. The two second sensing components 1940 are respectively positioned in the spaces formed by the annular structures of the fourth coils 1670 and 1680.

According to some embodiments of the present disclosure, the first sensing component 1910 is configured to sense the movement of the first movable portion 1200 around the Z-axis. The first sensing component 1920 is configured to sense the movement of the first movable portion 1200 around the Y-axis. The second sensing component 1930 is configured to sense the movement of the second movable portion 1500 around the Y-axis. The second sensing component 1940 is configured to sense the movement of the second movable portion 1500 around the Z-axis.

FIG. 6 shows a top cross-sectional view of the optical element driving mechanism 1000 taken along line A-A of FIG. 1 according to some embodiments of the present disclosure. The first support element 1710 provided in the first movable portion 1200 corresponds to the first corresponding element 1720 embedded in the second movable portion 1500. The second support element 1810 provided in the second movable portion 1500 corresponds to the second corresponding element 1820 embedded in the base 1120.

It should be understood that, in some embodiments, the first driving component 1300 (FIG. 2) is configured to drive the first movable portion 1200 to rotate about a first rotational axis R1 (parallel to the Y-axis) using the first support element 1710 as a fulcrum. The second driving component 1600 is configured to drive the second movable portion 1500 to rotate about a second rotational axis R2 (parallel to the Y-axis) using the second support element 1810 as a fulcrum.

The first movable portion 1200 is rotatable relative to the second movable portion 1500 about the first rotational axis R1 within a first range of motion. It should be understood that, as the movement of the second movable portion 1500 drives the first movable portion 1200 to move relative to the fixed portion 1100 (FIG. 2), the first movable portion 1200 is also rotatable relative to the fixed portion 1100 (FIG. 2) about a second rotational axis R2 within a second range of motion. It should be further understood that the first range of motion and the second range of motion are different. The second range of motion is smaller than the first range of motion. The first rotational axis R1 is parallel to the second rotational axis R2, and the first rotational axis R1 does not overlap with the second rotational axis R2.

Similarly, the first driving component 1300 is configured to drive the first movable portion 1200 to rotate about a third rotational axis (parallel to the Z-axis) using the first support element 1710 as a fulcrum. The second driving component 1600 is configured to drive the second movable portion 1500 to rotate about a fourth rotational axis (parallel to the Z-axis) using the second support element 1810 as a fulcrum.

The first movable portion 1200 is rotatable relative to the second movable portion 1500 about a third rotational axis within a third range of motion. It should be understood that, as the movement of the second movable portion 1500 drives the first movable portion 1200 to move relative to the fixed portion 1100 (FIG. 2), the first movable portion 1200 is also rotatable relative to the fixed portion 1100 (FIG. 2) about a fourth rotational axis within a fourth range of motion. It should be further understood that the third range of motion and the fourth range of motion are different. The fourth range of motion is smaller than the third range of motion. The third rotational axis is parallel to the fourth rotational axis, and the third rotational axis does not overlap with the fourth rotational axis.

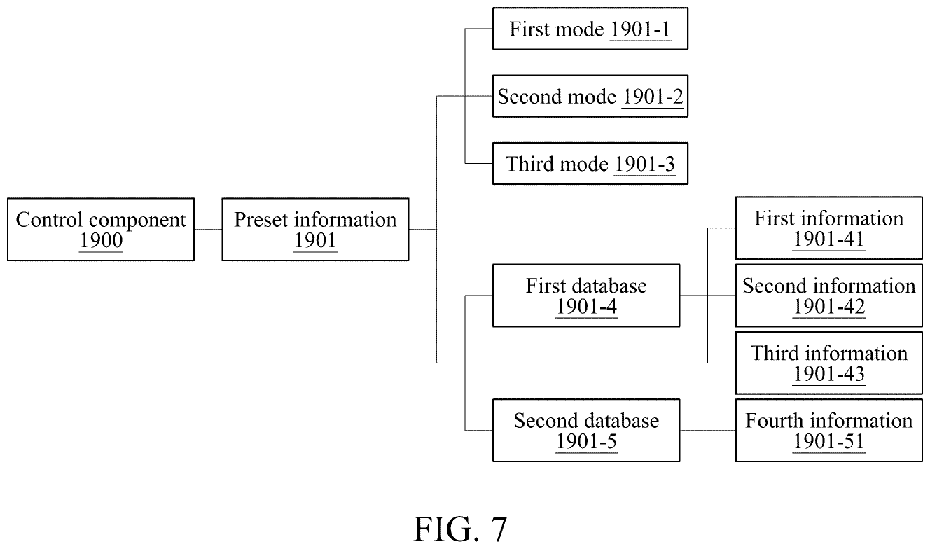

FIG. 7 shows a block diagram of preset information 1901 of the control component 1900 of the optical element driving mechanism 1000 according to some embodiments of the present disclosure. As shown in FIG. 7, the control component 1900 includes preset information 1901. The preset information 1901 includes a first mode 1901-1, a second mode 1901-2 and a third mode 1901-3. Please refer to FIG. 6 and FIG. 7 below.

According to some embodiments of the present disclosure, in the first mode 1901-1, the driving is intended for small-angle movements (e.g., when the optical element driving mechanism 1000 requires small-angle corrections). In the second mode 1901-2, the driving is intended for large-angle movements (e.g., when the optical element driving mechanism 1000 requires large-angle corrections). In the third mode 1901-3, the driving is intended to achieve parallel translation of the optical axis.

According to some embodiments of the present disclosure, in the first mode 1901-1, the second movable portion 1500 is fixed in a preset position, and the control component 1900 controls the movement of the first movable portion 1200 based on a first command. That is, only the first movable portion 1200 is driven to perform optical compensation in the first mode 1901-1.

According to some embodiments of the present disclosure, in the second mode 1901-2, the control component 1900 controls the second driving component 1600 (FIG. 2) to drive the second movable portion 1500 to move based on a second command, and the control component 1900 controls the first driving component to drive the first movable portion 1200 to move based on the first command.

In the second mode 1901-2, the movement directions of the first movable portion 1200 and the second movable portion 1500 are the same (e.g., the first movable portion 1200 and the second movable portion 1500 respectively rotate clockwise or counterclockwise in FIG. 6, using the first support element 1710 and the second support element 1810 as fulcrums).

According to some embodiments of the present disclosure, in the third mode 1901-3, the control component 1900 controls the second driving component to drive the movement of the second movable portion 1500 based on the second command, and controls the first driving component to drive the first movable portion 1200 to move based on the first command.

In the third mode 1901-3, the movement directions of the first movable portion 1200 and the second movable portion 1500 are opposite (e.g., the first movable portion 1200 and the second movable portion 1500 respectively rotate in opposite directions, with one rotating clockwise and the other counterclockwise, using the first support element 1710 and the second support element 1810 as fulcrums).

According to some embodiments of the present disclosure, a control unit (not shown) selects to drive the first driving component 1300 (FIG. 2) and the second driving component 1600 (FIG. 2) in the first mode 1901-1, the second mode 1901-2, or the third mode 1901-3 based on a primary command (provided by a central component of a smartphone, tablet, etc.), the preset information 1901, the first sensing signal, and the second sensing signal.

As shown in FIG. 7, the preset information 1901 further includes a first database 1901-4 and a second database 1901-5. The first database 1901-4 includes first information 1901-41, second information 1901-42, and third information 1901-43.

It should be understood that since the movement of the second movable portion 1500 drives the movement of the first movable portion 1200, it is necessary to perform correction and recording of the sensing signals to distinguish the sensing signals output by the first movable portion 1200 and the second movable portion 1500 at different positions and their actual positions.

First, it is necessary to observe the movement characteristics of the second movable portion 1500 and its effect on the first movable portion 1200, and collect relevant data as a basis for analysis. This can be achieved by recording multiple data points within the movement range of the second movable portion 1500 and measuring the travel of the first movable portion 1200 at each data point. Subsequently, the travel data of the first movable portion 1200 and the second movable portion 1500 are integrated to generate a dataset that describes the total travel variations of both, enabling further analysis.

During the measurement process, the movement range of the second movable portion 1500 is first measured, and multiple representative points are selected as references to record the corresponding data. Next, based on the movement data of the second movable portion 1500, the position of the first movable portion 1200 is adjusted, and its travel is measured at each point to ensure the completeness and accuracy of the data collection.

The motion strategy varies depending on the optical compensation requirements. When the optical compensation requirement is small, priority is given to driving the first movable portion 1200, while the second movable portion 1500 remains stationary. When the optical compensation requirement is large, the second movable portion 1500 is driven first to complete the corresponding movement, followed by the movement of the first movable portion 1200.

It should be noted that when the second movable portion 1500 is in motion, it is necessary to access the first database 1901-4 and the second database 1901-5 to obtain the motion state of the first movable portion 1200, thereby ensuring the coordination and accuracy of their movements. The data contents of the first database 1901-4 and the second database 1901-5 is described below.

According to some embodiments of the present disclosure, the first information 1901-41 includes reference information correlating the first sensing signal with the motion state of the first movable portion 1200 when the second movable portion 1500 is in a first preset state (e.g., the preset position shown in FIG. 6).

According to some embodiments of the present disclosure, the second information 1901-42 includes reference information correlating the first sensing signal with the motion state of the first movable portion 1200 when the second movable portion 1500 is in a second preset state (e.g., an extreme position).

According to some embodiments of the present disclosure, the third information 1901-43 includes reference information correlating the first sensing signal with the motion state of the first movable portion 1200 when the second movable portion 1500 is in a third preset state (e.g., another extreme position opposite to the second preset state). The first preset state, the second preset state, and the third preset state are distinct from each other.

According to some embodiments of the present disclosure, the second database 1901-5 includes fourth information 1901-51, which is reference information correlating the second sensing signal with the motion state of the second movable portion 1500. It should be understood that the control unit outputs the first command based on the primary command, the first sensing signal, the second sensing signal, and the preset information 1901. The control unit outputs the second command based on the primary command, the second sensing signal, and the preset information, but does not output the second command based on the first sensing signal.

In summary, the optical element driving mechanism disclosed herein includes two movable portions (the first movable portion and the second movable portion). Through specific design and driving control mechanisms, it not only achieves an increased compensation angle but also enables the optical element driving mechanism to provide stable and clear images even under larger offset scenarios.

Additionally, the present disclosure features coordinated movement of the two movable portions through precise data collection. In particular, referencing the databases during the motion process ensures accurate coordination and synchronized movement of the two movable portions, enabling the increased compensation angle to remain effectively applicable under larger offset scenarios. This further enhances the system's stability and operational efficiency.

While the embodiments of the present invention and their advantages have been disclosed as above, it should be understood that modifications, substitutions, and refinements can be made by those skilled in the art without departing from the spirit and scope of the present invention. Moreover, the scope of the present invention is not limited to the processes, machines, manufactures, compositions of matter, devices, methods, and steps specifically described in the embodiments within the specification. Those skilled in the art may understand, from the disclosure of the present invention, processes, machines, manufactures, compositions of matter, devices, methods, and steps currently known or developed in the future that perform substantially the same function or achieve substantially the same result as those in the disclosed embodiments, and such may be utilized in accordance with the present invention. Therefore, the scope of the present invention includes such processes, machines, manufactures, compositions of matter, devices, methods, and steps. Furthermore, each claim constitutes an individual embodiment, and the scope of the present invention also includes combinations of the various claims and embodiments.

What is claimed is:

1. A optical element driving mechanism, comprising:
a first movable portion for connecting a first optical element;
a fixed portion, wherein the first movable portion is movable relative to the fixed portion; and
a first driving component, configured to drive the first movable portion to move relative to the fixed portion.

2. The optical element driving mechanism as claimed in claim 1, further comprising:
a second movable portion, configured to connect a second optical element, wherein the second movable portion is movable relative to the fixed portion, and the first movable portion is movable relative to the second movable portion; and
a second driving component, configured to drive the second movable portion to move relative to the fixed portion.

3. The optical element driving mechanism as claimed in claim 2, wherein the first driving component is configured to drive the first movable portion to rotate around a first rotational axis, and the first movable portion is rotatable relative to the second movable portion within a first range of motion around the first rotational axis.

4. The optical element driving mechanism as claimed in claim 3, wherein the second driving component is configured to drive the second movable portion to rotate around a second rotational axis, and the first movable portion is rotatable relative to the fixed portion in a second range of motion around the second rotational axis.

5. The optical element driving mechanism as claimed in claim 4, wherein the first range of motion is different from the second range of motion, the second range of motion is smaller than the first range of motion, the first rotational axis is parallel to the second rotational axis, and the first rotational axis does not overlap the second rotational axis.

6. The optical element driving mechanism as claimed in claim 2, wherein when the second movable portion moves, the movement drives the first movable portion to move relative to the fixed portion.

7. The optical element driving mechanism as claimed in claim 2, wherein the first optical element adjusts the traveling direction of light from a first axis to a second axis, and the first axis and the second axis are not parallel to each other.

8. The optical element driving mechanism as claimed in claim 2, wherein the second optical element comprises a light-transmissible body with a finite focal length.

9. The optical element driving mechanism as claimed in claim 2, further comprising:
a first support component, wherein the first movable portion is movable relative to the fixed portion via the first support component, and the first movable portion is movable relative to the second movable portion via the first support component; and
a second support component, wherein the second movable portion is movable relative to the fixed portion via the second support component.

10. The optical element driving mechanism as claimed in claim 9, wherein the first support component comprises:
a first support element;
a first corresponding element corresponding to the first support element, wherein the first support element is movable relative to the first corresponding element; and
a first flexible element having a flexible structure, wherein the first flexible element is connected to the first movable portion, and the first flexible element is connected to the second movable portion.

11. The optical element driving mechanism as claimed in claim 10, wherein the second support component comprises:
a second support element;
a second corresponding element corresponding to the second support element, wherein the second support element is movable relative to the second corresponding element; and
a second flexible element having a flexible structure, wherein the second flexible element is connected to the second movable portion, and the second flexible element is connected to the fixed portion.

12. The optical element driving mechanism as claimed in claim 11, wherein the first flexible element and the second flexible element are located on opposite sides of the first optical element, and the first corresponding element is located between the first support element and the second support element.

13. The optical element driving mechanism as claimed in claim 2, further comprising a control component for controlling the first driving component and the second driving component, wherein the control component comprises preset information.

14. The optical element driving mechanism as claimed in claim 13, wherein the preset information comprises:
a first mode, fixing the second movable portion in a preset position and controlling the movement of the first movable portion based on a first command;
a second mode, controlling the second driving component to drive the second movable portion based on a second command, and controlling the first driving component to drive the first movable portion based on the first command, wherein in the second mode, movement directions of the first movable portion and the second movable portion are the same; and
a third mode, controlling the second driving component to drive the second movable portion based on the second command, and controlling the first driving component to drive the first movable portion based on the first command, wherein in the third mode, the first movable portion and the second movable portion move in opposite directions.

15. The optical element driving mechanism as claimed in claim 14, wherein the control component further comprises:
a first sensing component for sensing the movement of the first movable portion and outputting a first sensing signal; and
a second sensing component for sensing the movement of the second movable portion and outputting a second sensing signal.

16. The optical element driving mechanism as claimed in claim 15, wherein the control component comprises a control unit that selects among the first mode, the second mode, and the third mode for driving the first driving component and the second driving component based on a primary command, the preset information, the first sensing signal, and the second sensing signal.

17. The optical element driving mechanism as claimed in claim 16, wherein the preset information further comprises a first database, and the first database comprises:
first information, comprising reference information regarding the first sensing signal and a motion status of the first movable portion when the second movable portion is in a first preset state;
second information, comprising reference information regarding the first sensing signal and a motion status of the first movable portion when the second movable portion is in a second preset state; and
third information, comprising reference information regarding the first sensing signal and a motion status of the first movable portion when the second movable portion is in a third preset state, wherein the first preset state, the second preset state, and the third preset state are different from each other.

18. The optical element driving mechanism as claimed in claim 17, wherein the preset information further comprises a second database, and the second database comprises reference information regarding the second sensing signal and a motion status of the second movable portion.

19. The optical element driving mechanism as claimed in claim 15, wherein:
the control unit outputs the first command based on the primary command, the first sensing signal, the second sensing signal, and the preset information; and
the control unit outputs the second command based on the primary command, the second sensing signal, and the preset information.

20. The optical element driving mechanism as claimed in claim 19, wherein the control unit does not output the second command based on the first sensing signal.
